(19) United States
(12) Patent Application Publication
(10) Pub. No.: US 2015/0062321 A1
(43) Pub. Date: Mar. 5, 2015

(54) DEVICE CONTROL BY FACIAL FEATURE RECOGNITION

(71) Applicant: BLACKBERRY LIMITED, Waterloo (CA)

(72) Inventors: Peter Mankowski, Waterloo (CA); Ryan Alexander Geris, Kitchener (CA); Cornel Mercea, Waterloo (CA)

(73) Assignee: BLACKBERRY LIMITED, Waterloo (CA)

(21) Appl. No.: 14/011,505

(22) Filed: Aug. 27, 2013

(51) Int. Cl. G06K 9/00; G06F 3/01; G01S 7/52

(52) U.S. Cl. CPC G06K 9/00375; G01S 7/52023; G06F 3/013
USPC 348/78; 348/77

(57) ABSTRACT

An electronic device is controlled by scanning a face at an ultrasonic frequency, by at least one audio speaker. Facial features are mapped based on the scanning and repetitive movements of the facial features are detected by mapping the facial features over time. Future locations of the facial features are predicted based on the detecting of the repetitive movements. Control movements of the facial features are detected based on the mapping of the facial features and the predicting of the future locations of the facial features. The electronic device is controlled based on the detecting of the control movements.

### BACKGROUND

The present disclosure relates to facial feature recognition and, in particular, to controlling an electronic device by scanning a face with ultrasonic signals and recognizing facial features based on the ultrasonic signals.

Electronic devices typically use buttons, switches and other moving parts to make selections. Buttons include mechanical buttons and graphical buttons displayed on a touch-screen display. When mechanical buttons are used, multiple manufacturing steps may be employed to make the buttons, and over time the buttons wear down. In addition, foreign objects or particles may enter spaces between the buttons and a housing of the devices, which may result in device damage.

In some circumstances, the use of physical buttons or interfaces, where a user has to touch a device to cause the device to perform a function, may be inconvenient, such as when a user is holding a personal electronic device in one hand and has to hold on to something else with the other hand. Hands-free systems may be used to permit users to control functions of devices without pressing buttons or touch-screens with their hands. Cameras have been used to identify movements of a user, but cameras may be relatively expensive, especially high resolution models, while low-resolution cameras may not capture personal features or movements accurately. In addition, cameras suffer from detecting false positives and very high power consumption.

### BRIEF DESCRIPTION OF THE DISCLOSURE

According to an aspect of the disclosure, a method of controlling an electronic device includes scanning a face at an ultrasonic frequency, by at least one audio speaker and mapping facial features based on the scanning. The method further includes detecting repetitive movements of the facial features by mapping the facial features over time and predicting future locations of the facial features based on the detecting of the repetitive movements. In addition, the method includes detecting control movements of the facial features based on the mapping of the facial features and the predicting of the future locations of the facial features and controlling the electronic device based on detecting the control movements.

According to another aspect of the disclosure, an electronic device includes an ultrasonic audio speaker, a microphone, and a processing circuit. The processing circuit is configured to: receive signals from the microphone based on ultrasonic signals emitted by the ultrasonic audio speaker and reflected from a face, map the face based on the signals from the microphone, detect repetitive movements of facial features based on mapping the face over time, predict future positions of the facial features based on the detecting of the repetitive movements, detect a control motion of at least one of the facial features based on the predicting of the future positions of the facial features, and perform a predetermined function of the electronic device based on the predicting of the future positions.

According to yet another aspect of the disclosure, a method of controlling an electronic device includes scanning a face with a spectrum of ultrasonic signals, mapping the face based on the scanning of the face, detecting, by ultrasonic signals, a control movement of at least one facial feature, and controlling the electronic device based on the detecting of the control movement.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an electronic device according to an aspect of the disclosure;

FIG. 2 illustrates a flow diagram of a method according to an aspect of the disclosure;

FIG. 3 illustrates face mapping according to one aspect of the disclosure;

FIG. 4 illustrates face mapping according to an aspect of the disclosure;

FIG. 5 illustrates a flow diagram of a method of tracking an eye movement according to an aspect of the disclosure;

FIG. 6A illustrates tracking an eye movement according to an aspect of the disclosure; and

FIG. 6B illustrates tracking an eye movement according to an aspect of the disclosure.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

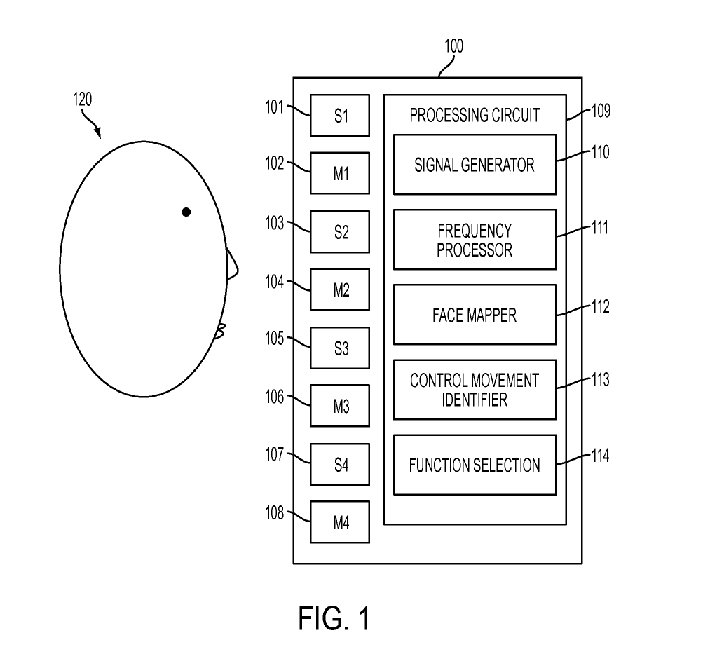

FIG. 1 illustrates an exemplary electronic device 100 according to an aspect of the disclosure. The device 100 includes ultrasonic audio speakers 101, 103, 105 and 107 and microphones 102, 104, 106, and 108. The device 100 also includes a processing circuit 109. The processing circuit 109 includes a signal generator 110 that controls the speakers 101, 103, 105, and 107 to generate ultrasonic signals. A frequency processor 111 receives data signals from the microphones 102, 104, 106 and 108 corresponding to the ultrasonic signals reflected off of a face 120. The frequency processor 111 may include analog-to-digital converters, filters, amplifiers, and other circuitry to receive the signals from the microphones 102, 104, 106, and 108 and process the signals.

The processing circuit 109 further includes a face mapper 112, which maps facial features based on the received ultrasonic signals. The face mapper 112 may also predict regular movements of the face, such as positions of facial features due to breathing. A control movement identifier 113 analyzes the detected ultrasonic signals to determine whether a control movement occurs, where a control movement is a pre-determined movement of one or more facial features that have been pre-designated to control a function of the electronic device 100. A function selection circuit 114 receives data regarding the control movement and initiates a function of the electronic unit 100 based on the control movement data. For example, selected functions may include adjusting a volume of the electronic device 100, scrolling up or down a document page or web page, turning a page from one page to the next, turning on or off the device 100, zooming in or out, or performing any other desired function.

While FIG. 1 illustrates four speakers 101, 103, 105, and 107 and four microphones 102, 104, 106, and 108, embodiments of the invention encompass any number of speakers and microphones. In addition, while FIG. 1 illustrates the speakers 101, 103, 105, and 107 and microphones 102, 104, 106, and 108 as being part of the electronic device 100, in some embodiments one or both of speakers and microphones are separate from the electronic device 100, and the one or more microphones transmit signals to the electronic device 100 to control the electronic device 100.

In embodiments of the invention, the signal generator 110, frequency processor 111, the face mapper 112, the control movement identifier 113, and the function selection circuit 114 include hardware elements and software elements (e.g., instructions stored in memory) that are executed by the processing circuit 109 to generate, process, and analyze signals. The hardware elements include logic circuits, memory, filters, amplifiers, registers, arithmetic logic units, and any other elements necessary to perform the above functions.

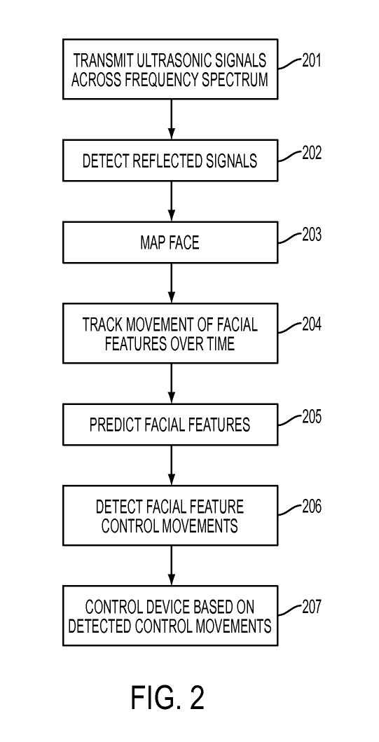

FIG. 2 is a flow diagram of a method according to an embodiment of the invention. In block 201, ultrasonic frequencies are transmitted across a frequency spectrum. In one embodiment, a signal generator generates ultrasonic signals across a range of ultrasonic frequencies. For example, the frequency generator may generate pulses at a first frequency to scan a face, increase or decrease the frequency by a predetermined amount, generate pulses at the second frequency, and continue to increment the frequency until pulses are generated at a predetermined number of different frequencies. In one embodiment, the frequency generator includes speakers or is connected to speakers to transmit the ultrasonic signals to the face being analyzed. In one embodiment, the range of frequencies is between 20 kHz and 42 kHz is predefined 5 millisecond (mS) bursts or pulses.

In block 202, reflected signals are detected. For example, one or more microphones may detect the ultrasonic signals that are reflected from the face being analyzed.

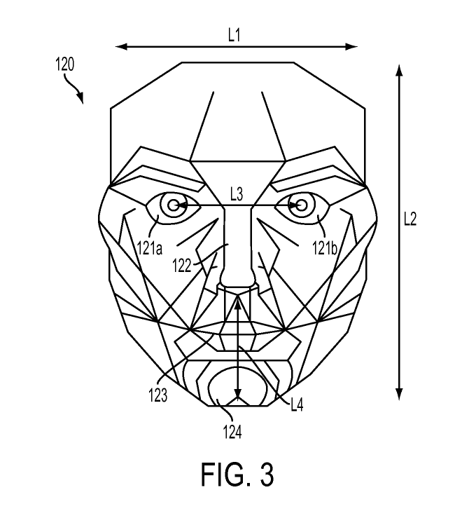

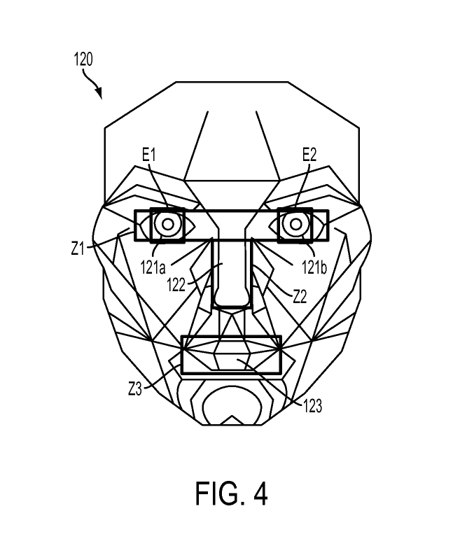

In block 203, the face being analyzed is mapped. In particular, the reflected frequencies are analyzed to map facial features. FIGS. 3 and 4 illustrate the mapping of a face according to an aspect of the disclosure. In particular, in FIG. 3, ultrasonic scanning is used to perform multiple sweeps over a face 120 to identify each feature, such as eyes 121a and 121b, a nose 122, a mouth 123, and a chin 124. In addition, relationships between the features are analyzed, including a width L1 of the face 120, a length L2 of the face 120, a distance L3 between the eyes 121a and 121b, a distance L4 between the nose 122 and the chin 124, and any other relationship for identifying facial features and mapping the face 120. Some examples of other relationships that are measured are distances between the eyes and nose, between the eyes and a top of the mouth, a middle of the mouth, and a bottom of the mouth, and any other relationships.

FIG. 4 illustrates further mapping of the face 120 by dividing the face 120 into zones according to a depth of the facial features. FIG. 4 illustrates a first zone Z1 corresponding to a depth including the eyes 121a and 121b, a second zone Z2 corresponding to a depth of the nose 122, and a third zone Z3 corresponding to a depth of mouth 123 or, in particular, the lips 123. In addition, the first zone Z1 may further be divided into a first sub-zone E1 corresponding to a first eye 121a and a second sub-zone E2 corresponding to a second eye 121b.

In addition to determining distances between facial features and dividing the face 120 into zones, the facial features are analyzed over time in block 204 to detect regular movements of the facial features, including regular movement of cheeks, lips, and nostrils corresponding to breathing and regular movements of eyes corresponding to blinking. Then the map of the face based on the geometric distances is synchronized with the measurements of the movement of facial features to detect regular patterns such a breathing and blinking.

In block 205, the locations of facial features are predicted based on the synchronized map and the detected movements of the facial features. In other words, the regular pattern of movement of the facial features is stored and updated as the face is scanned over time by the ultrasonic signals. For example, as regular breathing patterns of the nose and mouth are measured, the position of the eyes with respect to the nose and mouth are regularly re-calibrated.

In block 206, as the face is scanned over time by the ultrasonic signals, the detected facial features are compared with the predictions of the facial features based on the face map and the measured regular movements over time. In block 206, facial feature control movements are detected based on the comparison of the scanned facial features and the predicted facial features. For example, if a mouth is predicted to be at a first position based on regular breathing, and the mouth is detected as being in a second position, the second position may be determined to be a control movement to control a function of the electronic device (if the mouth movement is among the movements that have been pre-designated to control the device).

Finally, in block 207, the electronic device is controlled based on the detected control movement. The functions controlled according to embodiments of the invention include any function that can reasonably be associated with a detected movement of a facial feature, including any operation that requires only a single or double click or selection, such as a page change function, a scrolling function, a volume function, a power function, or any other similar function. The functions to be performed that are associated with the movement of facial features can be configured by a user through software executing on the electronic device. In such a manner, a user can select particular facial movements to control specific functions by assigning or associating the facial movements to control the desired functions.

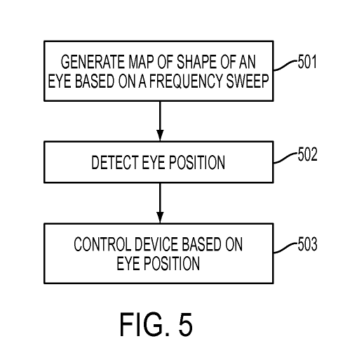

FIG. 5 is a flow diagram of detecting a facial feature according to one embodiment. In block 501, the scanning of the facial features and the mapping of the face includes scanning the shape of an eye, including a shape of an eyeball, using a sweep of ultrasonic signals across a range of frequencies. In block 502, the directional facing of the eye is detected based on the scanning. In block 503, the electronic device is controlled based on the detected directional facing of the eye.

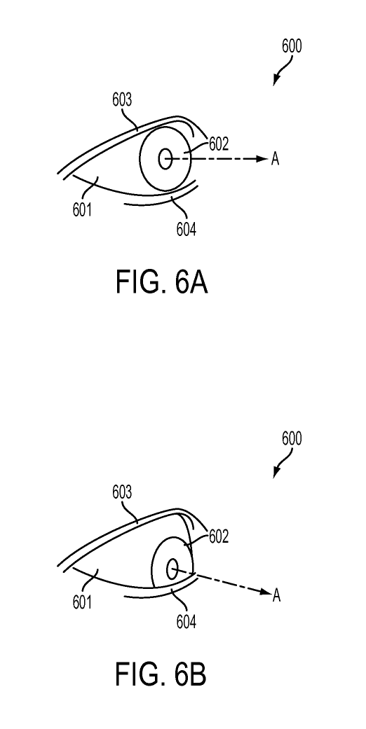

FIGS. 6A and 6B illustrate examples of eye positions that are detected to control an electronic device according to an aspect of the disclosure. In FIG. 6A, the shape of the eye 600, including the shape of the sclera 601, or the white part of the eye, and the bump of the cornea 602. In addition, the positions of the eyelids 603 and 604 are detected. Based on the location of the cornea 602, the directional facing of the eye 600 is determined. In FIG. 6A, the cornea 602 is located in the middle between the eyelids 603 and 604, and the directional facing A is determined to be approximately horizontal. In FIG. 6B, the cornea 602 is located partially under the lower eyelid 604, so the directional facing A of the eye 600 is determined to be downward.

In an example in which the directional facing A of the eye 600 controls the scrolling of a page, such as a word processing page or a web page displayed on an electronic device, determining that the eye is directed downward, as in FIG. 6B, may cause the page to turn or scroll. In another example, when it is detected that the eyelids 603 and 604 have closed (i.e., blinking) a function of the electronic device may be performed, such as making a selection, changing a displayed page, or any other function. For example, regular blinking of the eye may be determined over time, and it may be determined if the eyelids are closed at an irregular interval or for a predetermined duration of time. For example, closing both eyes for 1.5 seconds may initiate a function, such as a page scrolling function.

While detecting a directional facing of the eye has been provided by way of example, other aspects of the disclosure encompass controlling an electrical device based on any detected facial feature movement or head movement including performing a function, such as turning a page, when a user turns their head; detecting a circular motion of the head to perform a function, such as opening or closing a selected application; and performing a function, such as zooming in or out, based on detecting the tilt of a user's head. In another implementation, a function can be performed when a user moves their mouth, for example, if a smile is detected as a user is viewing material, such as text or video, the electronic device may prompt the user whether the user would like to add a tag or metadata to the material to indicate that the user likes the material, such as tagging the material as “liked” on a social media service. However, as discussed previously, these are provided only as examples, and the disclosure is not limited to the listed control movements of the face and head or the exemplary functions of an electronic device to be controlled using this methodology.

Aspects of the disclosure encompass any type of electronic device. In one embodiment, the electronic device is a cellular telephone having a touch-screen facing a user, and an ultrasonic transmitter (audio speaker) and microphone directed to the user, or in a same direction as the touch screen. In such an embodiment, the speaker and microphone are controlled by a processor in the cellular telephone to scan a user's face with the ultrasonic transmitter and microphone and detect control movements of the face. In other embodiments, the electronic device is a tablet computer, a laptop computer, or a desktop computer.

While aspects of the disclosure have been described with respect to handheld electronic devices, other embodiments may include electronic devices that are worn, such as eyeglasses or eye-pieces having ultrasonic transmitters and receivers, and a display.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method of controlling an electronic device, comprising:
scanning a face at an ultrasonic frequency, by at least one audio speaker;
mapping facial features based on the scanning;
detecting repetitive movements of the facial features by mapping the facial features over time;
predicting future locations of the facial features based on the detecting of the repetitive movements;
detecting control movements of the facial features based on the mapping of the facial features and the predicting of the future locations of the facial features; and
controlling the electronic device based on the detecting of the control movements.

2. The method of claim 1, wherein mapping the facial features includes mapping a shape of an eyeball to determine a directional facing of the eyeball, detecting the control movements includes detecting that the eyeball is directed at a bottom of a display screen, and
controlling the electronic device includes displaying new data on the display screen.

3. The method of claim 2, wherein the displaying new data includes at least one of scrolling data on the display screen and displaying a new page of data on the display screen.

4. The method of claim 1, wherein mapping the facial features includes dividing the face in to zones according to a depth of the facial features in the zones.

5. The method of claim 4, wherein a first zone includes eyes, a second zone includes a nose, and a third zone includes a mouth.

6. The method of claim 1, wherein scanning the face at the ultrasonic frequency includes scanning the face along a spectrum of ultrasonic frequencies.

7. The method of claim 6, wherein the at least one audio speaker includes at least four audio speakers.

8. The method of claim 7 wherein the at least four audio speakers are located in the electronic device.

9. The method of claim 1, wherein the repetitive movements are caused by at least one of breathing and blinking.

10. The method of claim 1, further comprising:
selecting, by a user, one or more of the facial features to be monitored to detect the control movements.

11. An electronic device, comprising:
at least one ultrasonic audio speaker;
at least one microphone; and
a processing circuit configured to: receive signals from the at least one microphone based on ultrasonic signals emitted by the at least one ultrasonic audio speaker and reflected from a face, map the face based on the signals from the at least one microphone, detect repetitive movements of facial features based on mapping the face over time, predict future positions of the facial features based on the detecting of the repetitive movements, detect a control motion of at least one of the facial features based on the predicting of the future positions of the facial features, and perform a predetermined function of the electronic device based on the predicting of the future positions.

12. The electronic device of claim 11, comprising at least four ultrasonic audio speakers.

13. The electronic device of claim 11, further comprising an audio control circuit configured to control the at least one ultrasonic audio speaker to generate a spectrum of ultrasonic audio signals to map the face.

14. The electronic device of claim 11, wherein the processing circuit is configured to map the face by dividing an image of the face formed by the received signals into different regions according to a depth of the region.

15. The electronic device of claim 11, wherein the processing circuit is configured to detect the repetitive movements of facial features over time by detecting an effect that breathing has on the facial features.

16. The electronic device of claim 11, wherein the processing circuit is configured to: map a shape of an eyeball, detect a facing of the eyeball based on the mapping of the shape of the eyeball, and control movement of a page on a display screen of the electronic device based on the facing of the eyeball.

17. The electronic device of claim 11, wherein the processing unit is configured to receive an input from a user, prior to the mapping of the face, to select the one or more facial features to be monitored to detect the control motions.

18. A method of controlling an electronic device, comprising:
scanning a face with a spectrum of ultrasonic signals;
mapping the face based on the scanning of the face;
detecting, by ultrasonic signals, a control movement of at least one facial feature; and
controlling the electronic device based on the detecting of the control movement.
